(19) United States
(12) Patent Application Publication
(10) Pub. No.: US 2024/0239669 A1
(43) Pub. Date: Jul. 18, 2024

(54) DEVICE AND METHOD FOR CRACKING BORON TRIFLUORIDE COMPLEX

(71) Applicants: Shandong Chengwu Yixin Environmental Technology Co., Ltd, Heze (CN); Zibo Yikang Environmental Protection Tech Co., Ltd, Zibo (CN)

(72) Inventors: Xianchong SUN, Heze (CN); Zhiyong ZOU, Heze (CN); Xingbiao FENG, Heze (CN); Jianshe WEI, Heze (CN); Tao FANG, Heze (CN)

(21) Appl. No.: 18/408,475

(22) Filed: Jan. 9, 2024

(30) Foreign Application Priority Data
Jan. 10, 2023 (CN) 202310030546.0

(51) Int. Cl. C01B 35/06; B01J 8/02

(52) U.S. Cl. CPC C01B 35/061; B01J 8/0242; B01J 2208/00194; B01J 2208/00345; B01J 2208/00407; C01P 2006/88

(57) ABSTRACT

The present disclosure relates to the technical field of separation of boron isotopes, in particular to a device and method for cracking a boron trifluoride complex. The device for cracking the boron trifluoride complex includes a continuous feeding system, a rising film preheater, a falling film preheater, a boron trifluoride gas circulation pipeline, a separation chamber, a cracking tower, a gas-liquid separator, an impurity removal tower, and anisole storage tank. By employing a continuous feeding method, the device for cracking boron trifluoride complex shortens retention time of anisole at a high-temperature stage while ensuring a cracking rate of a boron trifluoride-anisole complex, reduces the thermal decomposition degree of anisole, maintains the purity of anisole, and greatly improves the utilization rate and production safety of anisole, thus ensuring continuous and stable production.

### CROSS-REFERENCE TO RELATED APPLICATION

This patent application claims the benefit and priority of Chinese Patent Application No. 202310030546.0, filed with the China National Intellectual Property Administration on Jan. 10, 2023, the disclosure of which is incorporated by reference herein in its entirety as part of the present application.

### TECHNICAL FIELD

The present disclosure relates to the technical field of separation of boron isotopes, in particular to a device and method for cracking a boron trifluoride complex.

### BACKGROUND

There are two stable isotopes of boron in nature, boron-10 and boron-11, and their natural abundances are 19.8% and 80.2%, respectively. The boron-10, with the thermal neutron capture cross section of much larger than that of boron-11, has strong neutron absorption function and radiation protection function, and has been widely used in nuclear radiation shielding in nuclear power generation, and energy supply and neutron protection in national defense industry. Therefore, the boron-10 is widely used in the nuclear industry to manufacture thermal neutron counting tubes, reactor control rods and thermal neutron shielding materials, and is used in the science of medicine to treat glioma and melanoma. Boron trifluoride-11 electronic special gas has many applications in industrial production, which can be used in electronic industry and optical fiber industry. Boron trifluoride-11 is an important ion implantation gas in the semiconductor manufacturing process, and meanwhile, the boron trifluoride-11 is used in silicon ion implantation as a boron dopant, such that produced chips have the characteristics of high integration and high density, and are small in size and superior in performance. Nuclear-grade boron-10 acid and boron trifluoride-11 electronic special gas are both listed in “Guide Catalogue for the First Batch Application Demonstration of Key New Materials” issued by the Ministry of Industry and Information Technology of the People's Republic of China (2021 edition). In China, high-abundance boron isotopes mainly rely on imports, which limits the development of high-tech in China. With the progress of modern science and technology, the demands for high-abundance boron-10 and boron-11 is increasing worldwide. Therefore, it is of great economic and social value to improve boron isotope separation technology.

There are five main methods for producing boron isotopes at present: a boron trifluoride low-temperature distillation method, a boron trifluoride chemical exchange rectification method, an ion exchange resin method, a laser separation method, and an electromagnetic method. The boron trifluoride chemical exchange rectification method is the main method to produce boron isotopes in the world at present, which has a high single-stage boron isotope fractionation coefficient (about 1.03) and has reached the industrial production scale at present.

In the prior art, a method for cracking a boron trifluoride-anisole complex (a boron trifluoride complex for short) is as follows: A boron trifluoride-anisole complex is pumped into a feed port of a cracking tower, and in the falling process, due to the heating of a heating zone at a middle lower part of a tower body of the cracking tower, a small part of boron trifluoride-anisole complex is cracked, and most of the remaining boron trifluoride-anisole complex falls into a reboiler at the bottom of the tower together with the anisole obtained by cracking, and the complex is cracked after being heated for a long time in the reboiler. The main cracking power in the cracking procedure is the reboiler, the anisole obtained by cracking cannot be discharged from the reboiler in time, and is easy to be decomposed into phenol and ethylene after being unevenly heated for a long time at a high temperature condition, leading to that the purity of the anisole is reduced, and the boron isotope separation effect is affected. Moreover, the phenol is solid under normal temperature, which is easy to cause the blockage of the pipeline of a boron isotope separation system, and further leads to the paralysis of the whole production system and cause huge losses to industrial production. Therefore, it is necessary to find a device and method suitable for the cracking of a boron trifluoride-anisole complex, so as to improve the cracking efficiency, reduce the cost and improve the production safety.

### SUMMARY

The technical problem solved by the present disclosure is as follows: in the prior art, as the main cracking power for a boron fluoride-anisole complex is a reboiler, anisole obtained by cracking cannot be discharged from the reboiler in time, and is easy to be decomposed into phenol and ethylene after being unevenly heated for a long time at a high temperature condition, leading to that the purity of the anisole is reduced, and the boron isotope separation effect is affected. Moreover, a pipeline of a boron isotope separation system is prone to blockage, further leading to the paralysis of the whole production system and causing huge losses to industrial production.

For the technical problem above, a device and method for cracking a boron trifluoride-anisole complex are provided by the present disclosure. By employing a continuous feeding method, the device for cracking boron trifluoride complex shortens retention time of anisole at a high-temperature stage while ensuring a cracking rate of a boron trifluoride-anisole complex, reduces the thermal decomposition degree of anisole, maintains the purity of anisole, and greatly improves the utilization rate and production safety of anisole, thus ensuring continuous and stable production.

Specifically, the present disclosure employs the following technical solution:

In a first aspect, a device for cracking a boron trifluoride complex is provided, including a continuous feeding system 11, a rising film preheater 4, a falling film preheater 5, a separation chamber 6, a cracking tower 1, and a gas-liquid separator 14.

The continuous feeding system 11 is connected to the rising film preheater 4, the rising film preheater 4 is connected to the falling film preheater 5, and the falling film preheater 5 is connected to the separation chamber 6 and the cracking tower 1 in sequence. The cracking tower 1 is connected to an impurity removal tower 10 and an anisole storage tank 15 in sequence, and the cracking tower 1 is connected to the gas-liquid separator 14.

In some embodiments, a heat exchange type tube of the rising film preheater (4) has an inner diameter of 10-15 mm.

In some embodiments, a heat exchange type tube of the rising film preheater (4) has a length of 3-5 m.

In some embodiments, a heat exchange type tube of the falling film preheater (5) has an inner diameter of 10-15 mm.

In some embodiments, a heat exchange type tube of the falling film preheater (5) has a length of 3-5 m.

In some embodiments, a circulating refrigerant in the gas-liquid separator 14 is at a temperature of 5-25° C.

In some embodiments, a condenser 3 is installed at the top of the cracking tower 1, a normal temperature cooler 8 is connected to the bottom of the cracking tower 1, the normal temperature cooler 8 is connected to a low temperature cooler 9, the low temperature cooler 9 is connected to the impurity removal tower 10, and the impurity removal tower 10 is connected to the anisole storage tank 15.

In some embodiments, the top of the rising film preheater 4, the top of the falling film preheater 5 and the top of the separation chamber 6 are connected by a boron trifluoride gas circulation pipeline A 12. The top of the condenser 3 at the top of the cracking tower and the top of the gas-liquid separator 14 are connected by a boron trifluoride gas circulation pipeline B 13. The boron trifluoride gas circulation pipeline A 12 and the boron trifluoride gas circulation pipeline B 13 are connected to each other.

In some embodiments, the cracking tower 1 is a packed tower, a sieve-tray tower, or a bubble tower.

In some embodiments, packing used in the cracking tower 1 is orifice corrugated packing, Monel structured packing, or stainless steel 316L structured packing.

In some embodiments, the continuous feeding system 11 includes a boron trifluoride complex storage system.

In some embodiments, each of the rising film preheater 4, the falling film preheater 5 and the separation chamber 6 is provided with a gas mass flowmeter.

In some embodiments, the condenser 3 at the top of the cracking tower is provided with a liquid flowmeter to control a flow rate of the circulating refrigerant, so as to regulate and control a temperature of the condenser more accurately.

In a second aspect, a method for cracking a boron trifluoride complex using the device for cracking the boron trifluoride complex above is provided by the present disclosure, specifically including the following steps:
(1) pumping the boron trifluoride complex into a rising film preheater 4, and preheating the boron trifluoride complex through a falling film preheater 5 for early cracking, and enabling a boron trifluoride gas obtained by cracking to enter a gas-liquid separator 14;
(2) enabling uncracked boron trifluoride complex and a trace of boron trifluoride gas to enter a separation chamber 6 for full gas-liquid separation, and enabling a boron trifluoride gas to enter a gas-liquid separator 14;
(3) enabling uncracked boron trifluoride complex to enter a cracking tower 1 for cracking to obtain a boron trifluoride gas and anisole, cooling the boron trifluoride gas by a condenser 3 at the top of the cracking tower, and enabling the cooled boron trifluoride gas to enter the gas-liquid separator 14; discharging anisole from the bottom of the cracking tower 1, cooling and purifying the anisole, and finally enabling the anisole to enter an anisole storage tank 15; and
(4) enabling the boron trifluoride gas entering the gas-liquid separator 14 to enter a boron trifluoride-10 gas storage tank 7.

In some embodiments, the rising film preheater 4 is at a temperature of 110-130° C.

In some embodiments, the rising film preheater 4 is at a temperature of 120-130° C.

In some embodiments, the falling film preheater 5 is at a temperature of 130-150° C.

In some embodiments, the falling film preheater 5 is at a temperature of 140-150° C.

In some embodiments, the cracking tower 1 is at a temperature of 150-160° C.

In some embodiments, the cracking tower 1 is at a temperature of 155-158° C.

In some embodiments, the cracking tower 1 is at a pressure ranging from 0.6 bar to 1.2 bar.

In some embodiments, the cracking tower 1 is at a pressure ranging from 0.8 bar to 1.0 bar.

In some embodiments, a flow rate of the boron trifluoride-anisole complex in a heat exchange type tube of the rising film preheater 4 is 30-100 L/h.

In some embodiments, the flow rate of the boron trifluoride-anisole complex in the heat exchange type tube of the rising film preheater 4 is 60-100 L/h.

In some embodiments, flow time of the boron trifluoride-anisole complex in the heat exchange type tube of the rising film preheater 4 is 30-100 s.

In some embodiments, the flow time of the boron trifluoride-anisole complex in the heat exchange type tube of the rising film preheater 4 is 50-80 s.

In some embodiments, a flow rate of the boron trifluoride-anisole complex in a heat exchange type tube of the falling film preheater 5 is 30-100 L/h.

In some embodiments, the flow rate of the boron trifluoride-anisole complex in the heat exchange type tube of the falling film preheater 5 is 60-100 L/h.

In some embodiments, flow time of the boron trifluoride-anisole complex in the heat exchange type tube of the falling film preheater 5 is 30-100 s.

In some embodiments, the flow time of the boron trifluoride-anisole complex in the heat exchange type tube of the falling film preheater 5 is 50-80 s.

In some embodiments, the anisole is discharged from the bottom of the cracking tower 2, is further cooled by a normal temperature cooler 8 and a low temperature cooler 9 in sequence, then enters an impurity removal tower 10 for purification, and finally enters the anisole storage tank 15.

The present disclosure has the beneficial effects that by employing the continuous feeding process, the boron trifluoride-anisole complex can pass through the rising film preheater and the falling film preheater with higher heat exchange coefficients at one time, can be evenly heated with low heating temperature, short heating time and high cracking efficiency, and then can be heated by the cracking tower for the second time, thus ensuring that the complex reaching the bottom of the cracking tower is completely cracked into a boron trifluoride gas and anisole. The device for cracking boron trifluoride complex shortens the retention time of anisole at a high-temperature stage is shortened while ensuring the cracking rate of a boron trifluoride-anisole complex, reduces the thermal decomposition degree of anisole, maintains the purity of anisole, and greatly improves the utilization rate of the anisole, thus ensuring continuous and stable production of boron isotope products.

### BRIEF DESCRIPTION OF THE DRAWINGS

FIG. 1 is a process flow diagram of boron isotope separation;

FIG. 2 is a schematic diagram of a complex cracking device commonly used in the prior art;

where 1 denotes cracking tower, 2 denotes tower body heating part (heating system with heat conducting oil), 3 denotes anisole feed port, 4 denotes condenser, 5 denotes boron trifluoride pipeline, 6 denotes gas-liquid separator, 7 denotes boron fluoride pipeline, 8 denotes reboiler, 9 denotes impurity removal tower, 10 denotes anisole storage tank; and

FIG. 3 is a schematic diagram of a device for cracking of a boron trifluoride-anisole complex for boron isotope separation according to the present disclosure;

where 1 denotes cracking tower, 2 denotes tower body heating part (heating system with heat conducting oil), 3 denotes condenser, 4 denotes rising film preheater, 5 denotes falling film preheater, 6 denotes separation chamber, 7 denotes boron trifluoride-10 gas storage tank, 8 denotes normal temperature cooler, 9 denotes low temperature cooler, 10 denotes impurity removal tower, 11 denotes boron trifluoride complex feed port, 12 denotes boron trifluoride gas circulation pipeline A, 13 denotes boron trifluoride gas circulation pipeline B, 14 denotes gas-liquid separator (including low temperature cooling system), 15 denotes anisole storage tank, 16 denotes cooler, 17 denotes compressor.

### DETAILED DESCRIPTION OF THE EMBODIMENTS

According to literature reports in China and at aboard, an existing method for cracking a boron trifluoride-anisole complex is as follows: A boron trifluoride-anisole complex is pumped into a feed port of a cracking tower, and in the falling process, due to the heating of a heating zone at a middle lower part of a tower body of the cracking tower, a small part of boron trifluoride-anisole complex is cracked, and most of the remaining boron trifluoride-anisole complex falls into a reboiler at the bottom of the tower together with the anisole obtained by cracking, and the complex is cracked after being heated for a long time in the reboiler.

In above device, due to the limitation of the own heat transfer coefficient of a heating zone of the cracking tower, the cracking efficiency of the boron trifluoride-anisole complex in the tower is low, and the main power for cracking a boron trifluoride-anisole complex is a reboiler, the anisole obtained by cracking cannot be discharged from the reboiler in time, and is easy to be decomposed into phenol and ethylene after being unevenly heated for a long time under a high temperature condition. Anisole, as a complexing agent, is recycled in a boron isotope separation system for a long time. If the anisole is decomposed into phenol and ethylene under the high temperature condition, the purity of anisole is reduced, and the effect of boron isotope separation is affected. Moreover, the phenol is solid under a normal temperature, which is easy to cause the blockage of a pipeline of the boron isotope separation system, further leading to the paralysis of the whole production system and causing huge losses to industrial production. If the thermal decomposition of anisole is protected by lowering the heating temperature of reboiler, the heating time will be obviously prolonged and the boron trifluoride-anisole complex may not be completely cracked, and the incompletely cracked boron trifluoride-anisole complex will enter the next step of anisole impurity removal, which not only causes the waste of boron trifluoride gas, but also creates high pressure danger to the impurity removal procedure. Therefore, it is necessary to find a device and method suitable for the cracking of a boron trifluoride-anisole complex, so as to improve the cracking efficiency, reduce the cost and improve the production safety.

As above, an objective of the present disclosure is to provide a device and method for cracking a boron trifluoride complex. By employing a continuous feeding method, the retention time of anisole at a high-temperature stage is shortened while the cracking rate of a boron trifluoride-anisole complex is ensured, the thermal decomposition degree of anisole is reduced, the purity of anisole is maintained, and the utilization rate and production safety of anisole are greatly improved, and thus continuous and stable production is ensured.

In the present disclosure, a complex, a boron trifluoride complex and a boron trifluoride-anisole complex all refer to the boron trifluoride-anisole complex.

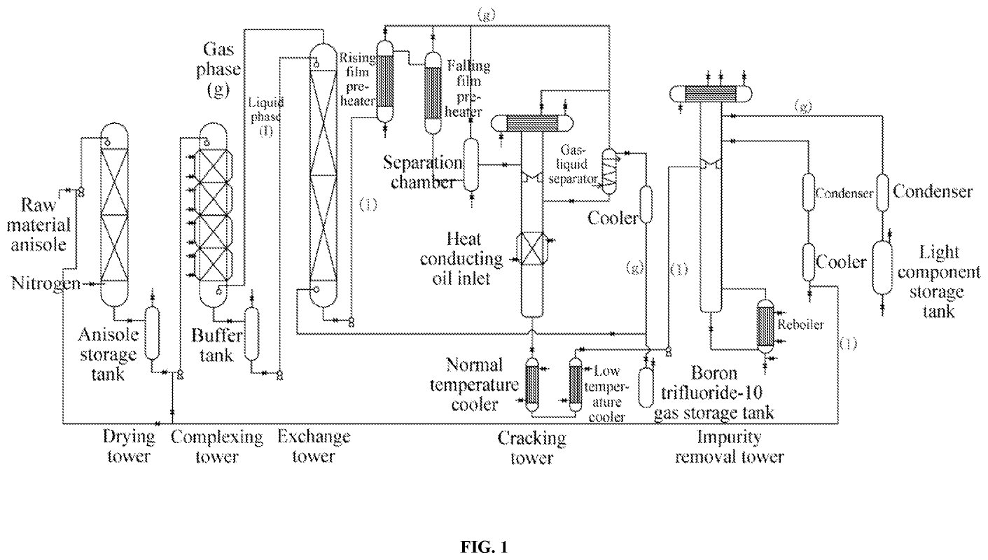

A process flow chart of boron isotope separation is shown in FIG. 1, which specifically includes the following steps: an anisole-boron trifluoride complex chemical exchange rectification method mainly consists of five working procedures: a complexing tower, an exchange tower, a cracking tower, an anisole impurity removal tower, and an anisole drying tower. In the complexing tower, natural-abundance boron trifluoride-11 gas is in countercurrent contact with anisole to cause a complexing reaction on the surface of packing, so as to generate a boron trifluoride-11-anisole complex. The boron trifluoride-11-anisole complex enters the exchange tower to continue the chemical exchange reaction with a boron trifluoride-10 gas, and the boron trifluoride-10 is gradually transferred from a gas phase to a liquid phase, and finally the boron trifluoride-10-anisole complex is slowly enriched in the liquid phase at the bottom of the exchange tower, and the boron trifluoride-11 gas is enriched at the top of the exchange tower, thus achieving the purpose of boron isotope separation. The enriched boron trifluoride-10 anisole complex enters the cracking tower for cracking reaction, the boron trifluoride-10 gas is separated, for product collection, the anisole obtained by cracking is further purified and dried, and the treated anisole is recycled again.

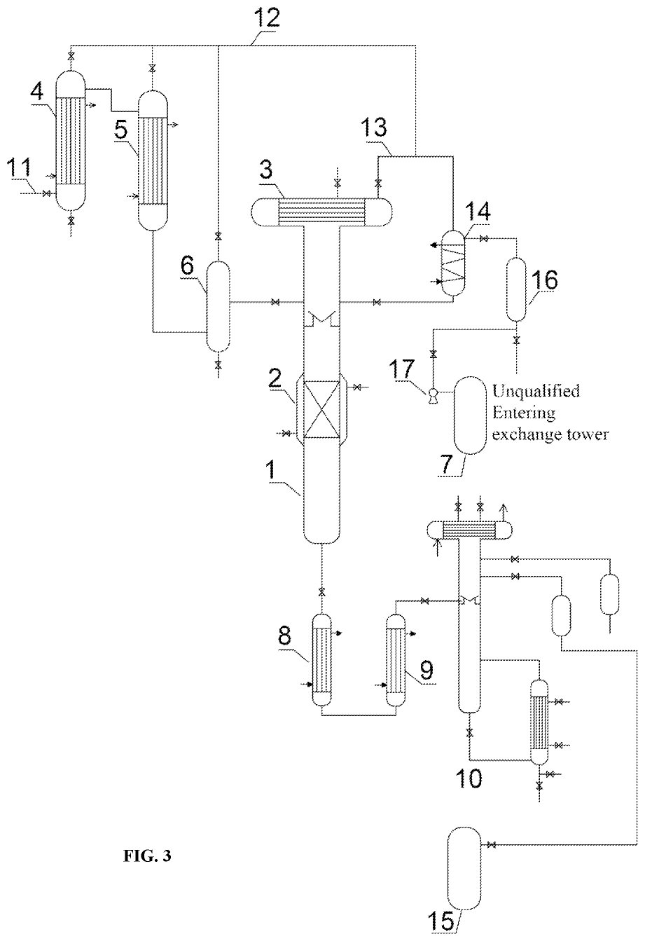

In a first aspect, a device for cracking a boron trifluoride complex is provided, as shown in FIG. 3, including a continuous feeding system 11, a rising film preheater 4, a falling film preheater 5, a separation chamber 6, a cracking tower 1, a gas-liquid separator 14, and a boron trifluoride-10 gas storage tank 7. The continuous feeding system 11 is connected to a lower part of the rising film preheater 4, an upper part of the rising film preheater 4 is connected to the falling film preheater 5, the falling film preheater 5 is connected to the separation chamber 6 and the cracking tower 1 in sequence. The cracking tower 1 is connected to an impurity removal tower 10 and an anisole storage tank 15 in sequence, and the cracking tower 1 is connected to the gas-liquid separator 14. The boron trifluoride-10 gas storage tank 7 is connected to an upper part of the gas-liquid separator 14. A condenser 3 is installed at the top of the cracking tower 1, a normal temperature cooler 8 is connected to the bottom of the cracking tower 1, the normal temperature cooler 8 is connected to a low temperature cooler 9, and the low temperature cooler 9 is connected to the impurity removal tower 10. Boron trifluoride gas circulation pipelines are arranged at the top of the rising film preheater 4, the top of the falling film preheater 5, the top of the separation chamber 6, the top of the condenser 3 of the cracking tower, and the top of the gas-liquid separator 14, and the gas pipelines are connected to one another.

In some embodiments, a heat exchange type tube of each of the rising film preheater 4 and the falling film preheater 5 has an inner diameter of 10-15 mm. Oversized inner diameter will affect the fluency of liquid and cause excessive pressure, while undersized inner diameter will lead to the reduction of the total surface area of the tube and affect the heating effect. That is, both undersized and oversized inner diameters of the heat exchange type tube will affect the cracking efficiency of the complex.

In some embodiments, the heat exchange type tube of each of the rising film preheater 4 and the falling film preheater 5 has a length of 3-5 m. If the tube is too long, the retention time of the complex in the rising film preheater and the falling film preheater is long, the heating time is prolonged and the cracking degree of the complex is increased, and a large amount of boron trifluoride gas is generated by cracking, but the upper part of each of the rising film preheater and the falling film preheater does not have the cooling effect, leading to that the temperature of the boron trifluoride gas entering the gas-liquid separator is excessively high, affecting the effect of gas-liquid separation. If the tube is too short, the retention time of the complex in the rising film preheater and the falling film preheater is short, the heating time is shortened, and the preheating effect of the rising film preheater and the cracking effect of the falling film preheater cannot be exerted. That is, the cracking efficiency of the complex will be affected by too long or too short tube.

In a second aspect, a method for cracking a boron trifluoride complex using the device for cracking the boron trifluoride complex above is provided by the present disclosure, specifically including the following steps:
(1) A boron trifluoride-anisole complex is pumped into a rising film preheater 4, and then is preheated by a falling film preheater 5 for early cracking, and a boron trifluoride gas obtained by cracking enters a gas-liquid separator 14 through boron trifluoride gas circulation pipelines at the top of the rising film preheater 4 and the top of the falling film preheater 5.
(2) Uncracked boron trifluoride complex and a trace of boron trifluoride gas enter a separation chamber 6 for full gas-liquid separation, and a boron trifluoride gas obtained by cracking enters the gas-liquid separator 14 through a boron trifluoride gas circulation pipeline at the top of the separation chamber 6.
(3) Uncracked boron trifluoride-anisole complex enters a cracking tower 1 for cracking to obtain a boron trifluoride gas and anisole.

The boron trifluoride gas obtained by cracking is cooled to a room temperature by a condenser 3 at the top of the cracking tower and then enters the gas-liquid separator 14 through a boron trifluoride gas circulation pipeline at the top of the condenser 3.

The anisole obtained by cracking is discharged from the bottom of the cracking tower 1, is further cooled by a normal temperature cooler 8 and a low temperature cooler 9 in sequence, then enters an impurity removal tower 10 for purification, and finally enters an anisole storage tank 15.
(4) The boron trifluoride gas entering the gas-liquid separator 14 enters a boron trifluoride-10 gas storage tank (7).

In some embodiments, the uncracked boron trifluoride complex discharged from the falling film preheater 5 enters the separation chamber 6, a small amount of boron trifluoride gas is mixed in the complex, and the complex is subjected to gas-liquid separation through a separation chamber 6 without a heating device. In addition, another objective of adding the separation chamber is to play a role of buffering and balancing pressure, such that the liquid can enter the cracking tower 1 smoothly.

In some embodiments, the boron trifluoride gas obtained by cracking enters the gas-liquid separator 14 through the boron trifluoride gas circulation pipeline. The gas-liquid separator is provided with a low-temperature refrigerant circulating device, which can liquefy a trace of steam carried by the boron trifluoride gas to complete gas-liquid separation, and the liquid enters the cracking tower 1 through a pipeline at the bottom of the gas-liquid separator 14. The boron trifluoride gas that is unqualified after detection enters the next procedure (exchange tower) through an upper side pipeline of the gas-liquid separator 14 to participate in the exchange reaction of the next procedure. The boron trifluoride-10 gas that is qualified after detection (the boron trifluoride-10 gas with an abundance of more than 60 is the qualified standard) enters the boron trifluoride-10 gas storage tank 7 after being compressed by a compressor through the upper side pipeline of the gas-liquid separator, as shown in FIG. 3.

Unless otherwise specified, all reagents/instruments used in the embodiments and comparative examples of the present disclosure are conventional commercial products.

A synthesis method of a boron trifluoride-anisole complex used in the present disclosure adopts some devices in FIG. 1, specifically including the following steps:
(1) A tower body refrigerant circulating system of the complexing tower is turned on to cool the complexing tower.
(2) Anisole in circulation is treated by an impurity removal tower and a drying tower in turn to obtain anisole with qualified content and moisture content (the content is 99.5% and more, and the moisture content within 50 ppm), and the obtained anisole is stored in the anisole storage tank.
(3) The qualified anisole is introduced into a liquid inlet at the top of the complexing tower, and a boron trifluoride-11 gas is simultaneously introduced into a gas inlet at the bottom of the complexing tower.
(4) A refrigerant system is regulated to ensure that the body of the complexing tower is at a temperature of 10-30° ° C., so as to obtain a boron trifluoride-11-anisole complex with a certain complexation degree.
(5) The boron trifluoride-11-anisole complex enters the exchange tower to continue the chemical exchange reaction with the boron trifluoride-10 gas. The boron trifluoride-11 gas is enriched at the top of the exchange tower, and the boron trifluoride-10 is gradually transferred from a gas phase to a liquid phase (due to the tiny separation coefficient (1.033), the boron trifluoride-10 and boron trifluoride-11 have different degrees of binding with anisole, the boron trifluoride 10 gas is easily complexed with anisole to form a complex which exists in a liquid form, and the boron trifluoride-11 exists alone in the form of gas), and finally the boron trifluoride-10-anisole complex is slowly enriched in the liquid phase at the bottom of the exchange tower, i.e., the raw material boron trifluoride-anisole complex used in the present disclosure.

For better understanding the technical solution of the present disclosure, the following clearly and completely describes the technical solutions of the present disclosure with reference to specific embodiments.

### Embodiment 1

The heat exchange type tube in the rising film preheater has an inner diameter of 10 mm and a length of 3 m. The heat exchange type tube in a falling film preheater has an inner diameter of 10 mm and a length of 3 m. A heat conducting oil valve is regulated to control the temperature of the rising film preheater to be 120° C. and the temperature of the falling film preheater to be 140° C. The circulating refrigerant in the gas-liquid separator is at a temperature of 5° ° C. In addition, the heat conduction oil valve is regulated to control a temperature of a heating zone of the cracking tower to be 150° C. and a pressure of the cracking tower to be 0.8 bar, and a working frequency of a material metering pump is set to regulate a flow rate of the boron trifluoride-anisole complex to be 60 L/hour, such that the time for the boron trifluoride-anisole complex to pass through the rising film preheater is 50 seconds and the time to pass through the falling film preheater is 50 seconds, and then the liquid phase boron trifluoride-anisole complex flows into the cracking tower by gravity. After continuous stable operation for 30 minutes, three consecutive samplings are conducted in the rising film preheater, the separation chamber and the bottom of the cracking tower, respectively. Detection results are shown in Table 1 below:

TABLE 1
Detection results of cracking rate of boron trifluoride-anisole

| | | | | | | | The bottom of | | |
|---|---|---|---|---|---|---|---|---|---|
| Sampling point | Rising film preheater | | | Separation chamber | | | cracking tower | | |
| Cracking rate % | 11.52 | 11.34 | 12.03 | 60.41 | 59.84 | 60.69 | 100 | 100 | 100 |

| Average | 11.63 | 60.31 | 100 |
|---|---|---|---|
| cracking rate % | | | |

As can be seen from the above table, the boron trifluoride-anisole complex reaching the bottom of the complexing tower is completely cracked, it is detected that the content of anisole is 99.996% and the content of phenol is 3.4 ppm. The cracking efficiency of the boron trifluoride-anisole complex is 60 L/hour.

In the detection of the content of anisole, the sample is collected at the bottom of the cracking tower, and the detection is conducted by FID (flame ionization detector) gas chromatography.

The calculation of the cracking rate is as follows:

The upper parts of the rising film preheater, the falling film preheater and the separation chamber are all provided with boron trifluoride gas circulation pipelines and gas mass flowmeters, and the cracking rate of the boron trifluoride-anisole can be calculated by combining the amount of boron trifluoride gas cracked at each part with the complexation degree of the complex and the amount of the complex.

$$Complexation degree = \frac{the mass {m}_{1} of boron trifluoride}{the mass m 1 of boron trifluoride + the mass {m}_{2} of anisole} \\ Cracking efficiency = \frac{the mass m of boron trifluoride obtained by cracking}{C o m p l e x ation degree of complex \times the mass {m}_{0} of complex}$$

Boron trifluoride gas is very soluble in water to produce boric acid and hydrofluoric acid, which further affects an acid value of anisole, and phenol in anisole also affects the acid value of anisole. When the content of phenol in the anisole is below 10 ppm, the acid value is affected to about 0.1 mg·KOH/g. Whether the acid value of the sample at the bottom of the cracking tower is about 0.1 mg·KOH/g or not is determined, if the acid value is lower than 0.1 mg·KOH/g, it can be determined that the complex has been completely cracked, and the flow rate of the complex entering the rising film preheater at this time corresponds to the corresponding cracking efficiency.

### Embodiment 2

The heat exchange type tube in the rising film preheater has an inner diameter of 15 mm and a length of 4 m. The heat exchange type tube in a falling film preheater has an inner diameter of 15 mm and a length of 4 m. A heat conducting oil valve is regulated to control the temperature of the rising film preheater to be 130° C. and the temperature of the falling film preheater to be 150° C. The circulating refrigerant in the gas-liquid separator is at a temperature of 5° C. In addition, the heat conduction oil valve is regulated to control a temperature of a heating zone of the cracking tower to be 155° C. and a pressure of the cracking tower to be 1.0 bar, and a working frequency of a material metering pump is set to regulate a flow rate of the boron trifluoride-anisole complex to be 80 L/hour, such that the time for the boron trifluoride-anisole complex to pass through the rising film preheater is 50 seconds and the time to pass through the falling film preheater is 50 seconds, and then the liquid phase boron trifluoride-anisole complex flows into the cracking tower by gravity. After continuous stable operation for 60 minutes, three consecutive samplings are conducted in the rising film preheater, the separation chamber and the bottom of the cracking tower, respectively. Detection results are shown in Table 2 below:

TABLE 2
Detection results of cracking rate of boron trifluoride-anisole

| | | | | | | | The bottom of | | |
|---|---|---|---|---|---|---|---|---|---|
| Sampling point | Rising film preheater | | | Separation chamber | | | cracking tower | | |
| Cracking rate/% | 11.76 | 11.69 | 11.94 | 58.48 | 59.65 | 59.11 | 100 | 100 | 100 |

| Average | 11.80 | 59.08 | 100 |
|---|---|---|---|
| cracking rate/% | | | |

As can be seen from the above table, the boron trifluoride-anisole complex reaching the bottom of the complexing tower is completely cracked, it is detected that the content of anisole is 99.994%, the content of phenol is 4.2 ppm, and the cracking efficiency of the boron trifluoride-anisole complex is 80 L/hour.

### Embodiment 3

The heat exchange type tube in the rising film preheater has an inner diameter of 12 mm and a length of 5 m. The heat exchange type tube in a falling film preheater has an inner diameter of 12 mm and a length of 5 m. A heat conducting oil valve is regulated to control the temperature of the rising film preheater to be 110° C. and the temperature of the falling film preheater to be 130° C. The circulating refrigerant in the gas-liquid separator is at a temperature of 15° C. In addition, the heat conduction oil valve is regulated to control a temperature of a heating zone of the cracking tower to be 158° C. and a pressure of the cracking tower to be 0.6 bar, and a working frequency of a material metering pump is set to regulate a flow rate of the boron trifluoride-anisole complex to be 30 L/hour, such that the time for the boron trifluoride-anisole complex to pass through the rising film preheater is 100 seconds and the time to pass through the falling film preheater is 100 seconds, and then the liquid phase boron trifluoride-anisole complex flows into the cracking tower by gravity. After continuous stable operation for 60 minutes, three consecutive samplings are conducted in the rising film preheater, the separation chamber and the bottom of the cracking tower, respectively. Detection results are shown in Table 3 below:

TABLE 3
Detection results of cracking rate of boron trifluoride-anisole

| | | | | | | | The bottom of | | |
|---|---|---|---|---|---|---|---|---|---|
| Sampling point | Rising film preheater | | | Separation chamber | | | cracking tower | | |
| Cracking rate/% | 10.87 | 11.09 | 11.01 | 56.32 | 57.15 | 56.55 | 100 | 100 | 100 |

| Average | 10.99 | 56.67 | 100 |
|---|---|---|---|
| cracking rate/% | | | |

As can be seen from the above table, the boron trifluoride-anisole complex reaching the bottom of the complexing tower is completely cracked, it is detected that the content of anisole is 99.996%, the content of phenol is 3.5 ppm, and the cracking efficiency of the boron trifluoride-anisole complex is 30 L/hour.

### Embodiment 4

The heat exchange type tube in the rising film preheater has an inner diameter of 15 mm and a length of 5 m. The heat exchange type tube in a falling film preheater has an inner diameter of 15 mm and a length of 4 m. A heat conducting oil valve is regulated to control the temperature of the rising film preheater to be 110° C. and the temperature of the falling film preheater to be 130° C. The circulating refrigerant in the gas-liquid separator is at a temperature of 25° C. In addition, the heat conduction oil valve is regulated to control a temperature of a heating zone of the cracking tower to be 160° C. and a pressure of the cracking tower to be 1.2 bar, and a working frequency of a material metering pump is set to regulate a flow rate of the boron trifluoride-anisole complex to be 100 L/hour, such that the time for the boron trifluoride-anisole complex to pass through the rising film preheater is 38 seconds and the time to pass through the falling film preheater is 30 seconds, and then the liquid phase boron trifluoride-anisole complex flows into the cracking tower by gravity. After continuous stable operation for 60 minutes, three consecutive samplings are conducted in the rising film preheater, the separation chamber and the bottom of the cracking tower, respectively. Detection results are shown in Table 4 below:

TABLE 4
Detection results of cracking rate of boron trifluoride-anisole

| | | | | | | | The bottom of | | |
|---|---|---|---|---|---|---|---|---|---|
| Sampling point | Rising film preheater | | | Separation chamber | | | cracking tower | | |
| Cracking rate/% | 11.34 | 11.25 | 11.37 | 60.48 | 59.59 | 59.47 | 100 | 100 | 100 |

| Average | 11.32 | 59.84 | 100 |
|---|---|---|---|
| cracking rate/% | | | |

As can be seen from the above table, the boron trifluoride-anisole complex reaching the bottom of the complexing tower is completely cracked, it is detected that the content of anisole is 99.994%, the content of phenol is 3.3 ppm, and the cracking efficiency of the boron trifluoride-anisole complex is 100 L/hour.

### Comparative Example 1

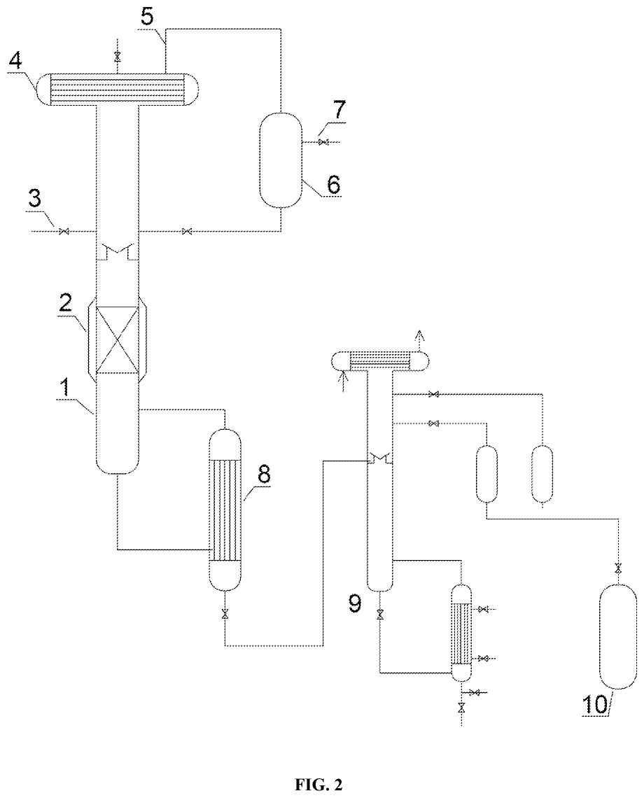

The device used in Comparative example 1 is the device in FIG. 2. The heat conduction oil valve is regulated to control the temperature of the heating zone of the cracking tower to 155° C., and in addition, the heat conduction oil valve is regulated to control a heating temperature of the reboiler at the bottom of the cracking tower to 160° ° C., the working frequency of the material metering pump is set to regulate a flow rate of the boron trifluoride-anisole complex to be 60 L/hour, and the boron trifluoride-anisole complex is delivered to a liquid inlet of the cracking tower. After 120 minutes, when the liquid in the reboiler reaches 70%-80% level, the operation of the material metering pump is suspended, and the delivery of the boron trifluoride-anisole complex is stopped. After the reboiler continues to heat for 0 minute, 30 minutes, 60 minutes, 80 minutes, 100 minutes, 110 minutes and 120 minutes, samplings are conducted in the reboiler, respectively. Detection results are shown in Table 5 below:

TABLE 5
Detection results of cracking rate of boron trifluoride-anisole

| Time/min | 0 | 30 | 60 | 80 | 100 | 110 | 120 |
|---|---|---|---|---|---|---|---|
| Cracking | 52 | 67 | 79 | 87 | 95 | 98 | 100 |
| rate/% | | | | | | | |

As can be seen from the above table, after 120 minutes, the boron trifluoride-anisole complex is completely cracked, it is detected that the content of anisole is 99.91%, the content of phenol is 26 ppm, and the cracking efficiency of the boron trifluoride-anisole complex is 30 L/hour.

The specific embodiments of the present disclosure have been described above, which are not intended to limit the scope of protection of the present disclosure, On the basis of the technical solution of the present disclosure, various modifications or variations made by those skilled in the art without creative labor are still within the scope of protection of the present disclosure.

What is claimed is:

1. A device for cracking a boron trifluoride complex, the device comprising a continuous feeding system, a rising film preheater, a falling film preheater, a separation chamber, a cracking tower, and a gas-liquid separator, the continuous feeding system being connected to the rising film preheater, the rising film preheater being connected to the falling film preheater, the falling film preheater being connected to the separation chamber and the cracking tower in sequence, and the cracking tower being connected to the gas-liquid separator.

2. The device for cracking a boron trifluoride complex according to claim 1, wherein a heat exchange type tube of the rising film preheater has an inner diameter of 10-15 mm and a length of 3-5 m; and/or a heat exchange type tube of the falling film preheater has an inner diameter of 10-15 mm, and a length of 3-5 m.

3. The device for cracking a boron trifluoride complex according to claim 1, wherein a circulating refrigerant in the gas-liquid separator is at a temperature of 5-25° C.

4. The device for cracking a boron trifluoride complex according to claim 1, wherein a condenser is installed at the top of the cracking tower, a normal temperature cooler is connected to the bottom of the cracking tower, the normal temperature cooler is connected to a low temperature cooler, the low temperature cooler is connected to an impurity removal tower, and the impurity removal tower is connected to an anisole storage tank.

5. The device for cracking a boron trifluoride complex according to claim 1, wherein the top of the rising film preheater, the top of the falling film preheater and the top of the separation chamber are connected by a boron trifluoride gas circulation pipeline A, wherein the top of the condenser at the top of the cracking tower and the top of the gas-liquid separator are connected by a boron trifluoride gas circulation pipeline B, and wherein the boron trifluoride gas circulation pipeline A and the boron trifluoride gas circulation pipeline B are connected to each other.

6. The device for cracking a boron trifluoride complex according to claim 1, wherein a cracking tower is a packed tower, a sieve-tray tower, or a bubble tower.

7. The device for cracking a boron trifluoride complex according to claim 1, wherein the continuous feeding system comprises a boron trifluoride complex storage system.

8. A method for cracking a boron trifluoride complex using the device for cracking the boron trifluoride complex according to claim 1, comprising the following steps:
(1) pumping the boron trifluoride complex into a rising film preheater, and preheating the boron trifluoride complex through a falling film preheater for early cracking, and enabling a boron trifluoride gas obtained by cracking to enter a gas-liquid separator;
(2) enabling uncracked boron trifluoride complex and a trace of boron trifluoride gas to enter a separation chamber for full gas-liquid separation, and enabling a boron trifluoride gas to enter a gas-liquid separator;
(3) enabling uncracked boron trifluoride complex to enter a cracking tower for cracking to obtain a boron trifluoride gas and anisole, cooling the boron trifluoride gas by a condenser at the top of the cracking tower, and enabling the cooled boron trifluoride gas to enter the gas-liquid separator; discharging anisole from the bottom of the cracking tower, cooling and purifying the anisole, and finally enabling the anisole to enter an anisole storage tank; and
(4) enabling the boron trifluoride gas entering the gas-liquid separator to enter a boron trifluoride-10 gas storage tank.

9. The method for cracking a boron trifluoride complex according to claim 8, wherein a heat exchange type tube of the rising film preheater has an inner diameter of 10-15 mm, and a length of 3-5 m; and/or a heat exchange type tube of the falling film preheater has an inner diameter of 10-15 mm, and a length of 3-5 m.

10. The method for cracking a boron trifluoride complex according to claim 8, wherein a circulating refrigerant in the gas-liquid separator is at a temperature of 5-25° C.

11. The method for cracking a boron trifluoride complex according to claim 8, wherein a condenser is installed at the top of the cracking tower, a normal temperature cooler is connected to the bottom of the cracking tower, the normal temperature cooler is connected to a low temperature cooler, the low temperature cooler is connected to an impurity removal tower, and the impurity removal tower is connected to an anisole storage tank.

12. The method for cracking a boron trifluoride complex according to claim 8, wherein the top of the rising film preheater, the top of the falling film preheater and the top of the separation chamber are connected by a boron trifluoride gas circulation pipeline A, wherein the top of the condenser at the top of the cracking tower and the top of the gas-liquid separator are connected by a boron trifluoride gas circulation pipeline B, and wherein the boron trifluoride gas circulation pipeline A and the boron trifluoride gas circulation pipeline B are connected to each other.

13. The method for cracking a boron trifluoride complex according to claim 8, wherein a cracking tower is a packed tower, a sieve-tray tower, or a bubble tower.

14. The method for cracking a boron trifluoride complex according to claim 8, wherein the continuous feeding system comprises a boron trifluoride complex storage system.

15. The method for cracking a boron trifluoride complex according to claim 8, wherein:
the rising film preheater is at a temperature of 110-130° C.;
the falling film preheater is at a temperature of 130-150° C.;
the cracking tower is at a temperature of 150-160° C.; or
the cracking tower is at a pressure of 0.6-1.2 bar.

16. The method for cracking a boron trifluoride complex according to claim 9, wherein:
the rising film preheater is at a temperature of 110-130° ° C.;
the falling film preheater is at a temperature of 130-150° C.;
the cracking tower is at a temperature of 150-160° C.; and/or
the cracking tower is at a pressure of 0.6-1.2 bar.

17. The method for cracking a boron trifluoride complex according to claim 10, wherein:
the rising film preheater is at a temperature of 110-130° C.;
the falling film preheater is at a temperature of 130-150° C.;
the cracking tower is at a temperature of 150-160° C.; and/or
the cracking tower is at a pressure of 0.6-1.2 bar.

18. The method for cracking a boron trifluoride complex according to claim 11, wherein:
the rising film preheater is at a temperature of 110-130° C.;
the falling film preheater is at a temperature of 130-150° ° C.;
the cracking tower is at a temperature of 150-160° ° C.; and/or
the cracking tower is at a pressure of 0.6-1.2 bar.

19. The method for cracking a boron trifluoride complex according to claim 8, wherein a flow rate and flow time of the boron trifluoride-anisole complex in a heat exchange type tube of the rising film preheater are 30-100 L/h and 30-100 s, respectively, and/or, a flow rate and flow time of the boron trifluoride-anisole complex in a heat exchange type tube of the falling film preheater are 30-100 L/h and 30-100 s, respectively.

20. The method for cracking a boron trifluoride complex according to claim 8, wherein the anisole is discharged from the bottom of the cracking tower (2), is further cooled by a normal temperature cooler and a low temperature cooler in sequence, then enters an impurity removal tower for purification, and finally enters the anisole storage tank.
